(19) United States
(12) Patent Application Publication
(10) Pub. No.: US 2016/0137886 A1
(43) Pub. Date: May 19, 2016

(54) SYSTEMS AND METHODS FOR JOINING CONDUCTIVE SURFACES USING A RELEASABLE ADHESIVE

(71) Applicant: GM Global Technology Operations LLC, Detroit, MI (US)

(72) Inventors: Ryan C. Sekol, Grosse Pointe Woods, MI (US); Jeffrey A. Abell, Rochester Hills, MI (US)

(21) Appl. No.: 14/937,775

(22) Filed: Nov. 10, 2015

Related U.S. Application Data
(60) Provisional application No. 62/079,365, filed on Nov. 13, 2014.

(51) Int. Cl. C09J 9/02; B32B 37/12; B32B 37/14; B32B 7/14

(52) U.S. Cl. CPC C09J 9/02; B32B 7/14; B32B 37/12; B32B 37/14; B32B 2405/00; B32B 2307/748; B32B 2307/302; B32B 2307/202

(57) ABSTRACT

Provided is a releasable adhesive system, for joining a first conductive surface and a second conductive surface. The releasable adhesive includes primary material and an embedded material. The primary material includes at least one molecule that is configured to be positioned parallel with at least one molecule of the first conductive surface or the second conductive surface. The embedded material is infused within or affixed to the primary material to form an adhesive structure. The releasable adhesive structure has a conductivity greater than a conductivity of the primary material alone. Also provided is a method for joining the first conductive surface to the second conductive surface using the adhesive structure.

### CLAIM OF PRIORITY

This application claims the benefit of U.S. Provisional Application No. 62/079,365, filed Nov. 13, 2014.

### TECHNICAL FIELD

The present disclosure relates generally to systems and method for temporarily or permanently joining two surfaces. More specifically, the present disclosure relates to systems and methods for temporarily or permanently joining two surfaces using a releasable adhesive.

### BACKGROUND

Joining surfaces of similar or dissimilar materials can often require extensive processes such as applying permanent adhesives and welding. However, accessing the surfaces after joining, such as by assembly personnel or machinery, can be difficult due to the permanent nature of the adhesives and welds. Limited access to the surfaces can make repairs more difficult.

Permanent joining processes (e.g., ultrasonic welding, resistance spot welding, laser welding, and riveting) can require large capital expenditures for equipment and tooling. Additionally, operations can be interrupted by lengthy changeovers when equipment and tooling need to be replaced.

Reversible joining processes can also be used to join similar or dissimilar materials. Magnets are commonly used to join surfaces temporarily, such as when transporting an object from a staging area to a manufacturing assembly line. Suction connections are also commonly used to join surfaces temporarily in material handling through the use of manual or vacuum-operated suction.

Although magnets and suction connections are reversible in nature, the bond formed can be weakened by impurities on any of the relevant surfaces, which can lead to diminished bonding in the magnetic or suction-based connection. For example, oil or dirt on a surface of a part being joined, or of a magnet or suction cup, can substantially weaken the bond formed at the joining surfaces. Additionally, air pockets present at or in the joining surfaces can lead to a potential loss of connection.

### SUMMARY

A need exists for a bonding adhesive that is reversible in nature, or releasable, after installation. The adhesive would have load-carrying capabilities when attached to a surface, and be able to release quickly to disjoin from the surface upon a predetermined amount of peel force.

The present technology relates to systems including a releasable adhesive having many applications including in commercial industry, the private-sector (e.g., consumer), and manufacturing, among others. The releasable adhesive joins a first conductive surface with a second conductive surface and includes primary material and a conductive embedded material. The primary material has at least one molecule that is configured to be positioned parallel with at least one molecule of the first conductive surface or the second conductive surface. The conductive embedded material is infused within or affixed to the primary material to form an adhesive structure. The releasable adhesive structure has a conductivity greater than a conductivity of the primary material alone.

The releasable adhesive forms a reversible bond that utilizes van der Waals force to adhere to a surface. In some embodiments, the adhesive structure is configured to be removed from the first conductive surface or the second conductive surface in response to a peel force applied perpendicular to the at least one molecule of the first conductive surface or the second conductive surface.

In some embodiments, the conductive embedded material forms a continuous surface providing an uninterrupted electrical pathway from the first conductive surface to the second conductive surface. In some embodiments, the conductive embedded material includes a plurality of conductive particles positioned in proximity to one another forming an electrical pathway from the first conductive surface to the second conductive surface.

In some embodiments, the embedded material is selected to reinforce strength of the primary material. Reinforcing strength of the primary material allows the primary material to sustain against greater shear forces and/or pull forces.

In some embodiments, the embedded material is selected to increase electrical and/or thermal conductivity of the primary material. Increasing conductivity of the primary material allows the primary material to serve as an adhesive as well as a conductor of energy (e.g., electricity). In applications, where electric current need to pass through the primary material and an attaching surface.

In some embodiment, the releasable adhesive includes the primary material formed into an array of element structures. In some embodiments, the element structures are arranged in and/or on setae (e.g., synthetic setae), such as by the conductive embedded material being infused within the primary material. In other embodiments, the conductive embedded material is infused into some (e.g., selected) but not all of the setae.

In one embodiment, the releasable adhesive is formed as a flexible structure that can be connected, e.g., molded, to or around an attaching surface. In one embodiment, the flexible structure is in the form of one-sided tape, and in another embodiment, the flexible structure is in the form of a double-sided tape.

Other aspects of the present technology are described hereinafter.

### DESCRIPTION OF THE DRAWINGS

FIG. 1 illustrates a side view of a removable adhesive in accordance with an embodiment of the present technology.

FIG. 2 is a perspective view of an alternative embodiment of the removable adhesive of FIG. 1.

FIG. 3 is a perspective view of another alternative embodiment of the removable adhesive of FIG. 1.

FIG. 4 is a side view of another alternative embodiment of the removable adhesive of FIG. 1.

FIG. 5 is a perspective view of another alternative embodiment of the removable adhesive of FIG. 1.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

While the present technology is described primarily herein in connection with automobiles, the technology is not limited to automobiles. The concepts can be used in a wide variety of vehicle applications, such as in connection with aircraft, marine craft, and other vehicles, and consumer electronic components. Additionally, the concepts can be used in a variety of consumer applications, such as electronic components, clothing design (e.g., fasteners and closures), apparel gripping (e.g., work gloves and sports gloves), and signs (e.g., permanent signage for a business and temporary signage for a traffic detour), among others. Furthermore, the concepts can be used in low temperature environments (e.g., aeronautical applications in space) where conventional adhesives lose gripping.

Various embodiments of the present disclosure are disclosed herein. The disclosed embodiments are merely examples that may be embodied in various and alternative forms, and combinations thereof.

### I. Overview of the Disclosure

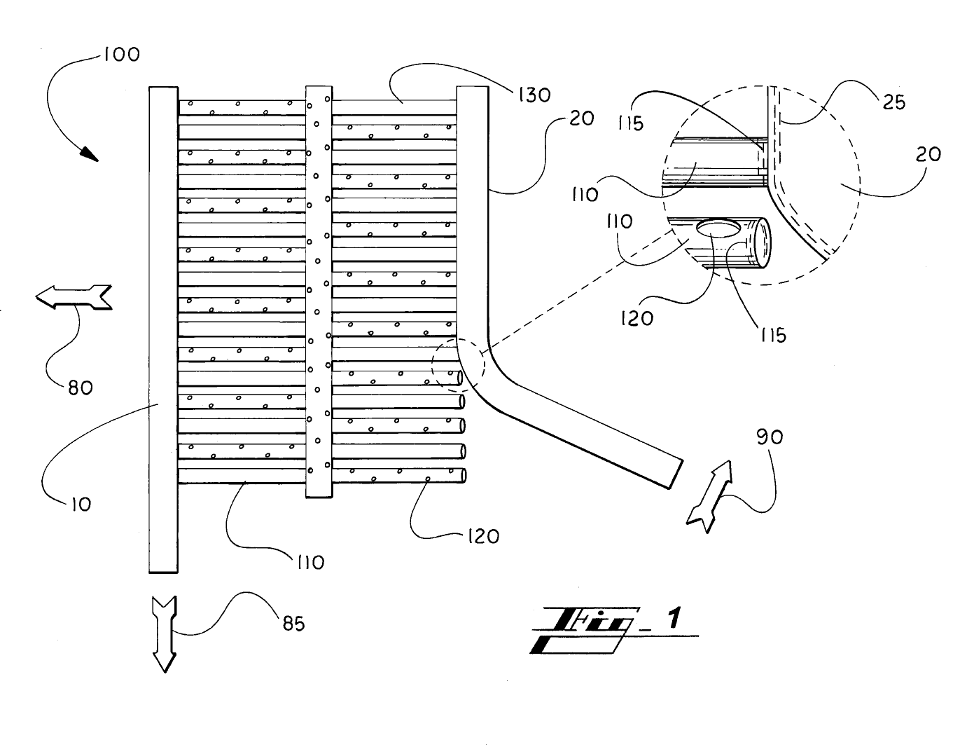

FIG. 1 illustrates a releasable adhesive 100, which allows reversible bonding through the use of van der Waals force. The releasable adhesive 100 adheres and releases from a first surface 10 and a second surface 20 where surface 10, 20 are substantially solid surfaces made of varying materials and textures of the surfaces 10, 20.

The releasable adhesive 100 comprises a primary material 110 that has particles (e.g., molecules, atoms, ions) generally parallel with respect to particles within the first surface 10, the second surface 20. As illustrated in the callout of FIG. 1, molecules 115 of the primary material 110 are parallel with molecules 25 of the second surface 20, at a location of attachment. Van der Waals force allows the molecules 115 of the primary material 110 to adhere to the second surface 20. Specifically, the molecules 115 of the primary material 110 maintain a bond between the releasable adhesive 100 and an attaching surface (e.g., the second surface 20) against pull forces 80 and shear forces 85.

Unlike a traditional chemical bonding process required by typical adhesives, the releasable adhesive 100 does not require curing, thus allowing the releasable adhesive 100 to adhere to the surfaces 10, 20 almost instantaneously. The releasable adhesive 100 can also adhere to the surface 10, 20 without use of an external power supply, actuator, or otherwise.

Van der Waals force also allows the bond between the molecules 115 of the primary material 110 and the molecules of the attaching surface (e.g., the molecules 25 of the second surface 20) to detach when peel forces 90 are applied to the surfaces attaching surface or the releasable adhesive 100. As illustrated in the callout of FIG. 1, where the primary material 110 is not in contact with to the second surface 20, the molecules 115 of the primary material 110 are not generally parallel to the molecules 25 of the second surface 20.

In some embodiments, the primary material 110 includes a microstructured and/or a nanostructured polymer, such as silicone and polydimethylsiloxane (PDMS), among others. In some embodiments, the primary material 110 includes polymers such as (functionalized) polycarbonate, polyolefin (e.g., polyethylene and polypropylene), polyamide (e.g., nylons), polyacrylate, acrylonitrile butadiene styrene.

In some embodiments, the primary material 110 includes composites such as reinforced plastics where the plastics may include any of the exemplary polymers listed above, and the reinforcement may include one or more of the following: clay, glass, carbon, polymer in the form of particulate, fibers (e.g., nano, short, or long fibers), platelets (e.g., nano-sized or micron-sized platelets), and whiskers, among others.

The primary material 110 can include synthetic or inorganic, molecules. While use of so-called biopolymers (or, green polymers) is becoming popular in many industries, petroleum based polymers are still much more common in every-day use. The primary material 110 may also include recycled material, such as a polybutylene terephthalate (PBT) polymer, being, e.g., about eighty-five percent post-consumer polyethylene terephthalate (PET). In one embodiment, the primary material 110 includes some sort of plastic. In one embodiment, the material includes a thermoplastic.

In one embodiment the primary material 110 includes a composite. For example, the primary material 110 can include a fiber-reinforced polymer (FRP) composite, such as a carbon-fiber-reinforced polymer (CFRP), or a glass-fiber-reinforced polymer (GFRP). The composite may be a fiberglass composite, for instance. In one embodiment, the FRP composite is a hybrid plastic-metal composite (e.g., plastic composite containing metal reinforcing fibers). The primary material 110 in some implementations includes a polyamide-grade polymer, which can be referred to generally as a polyamide. In one embodiment, the primary material 110 includes acrylonitrile-butadiene-styrene (ABS). In one embodiment, the primary material 110 includes a polycarbonate (PC). The primary material 110 may also comprise a type of resin. Example resins include a fiberglass reinforced polypropylene (PP) resin, a PC/PBT resin, and a PC/ABS resin.

### II. Embodiments of the Releasable Adhesive

In the embodiment shown in FIG. 1, the releasable adhesive 100 comprises a plurality of setae 130 (e.g., synthetic setae). Van der Waals force allows the primary material 110 within/on each setae 130 to adhere and release to the surfaces 10, 20 using attractions and repulsions between particles (e.g., atoms, molecules, ions) of the primary material 110 and the surfaces 10, 20.

As described above, van der Waals force allows the molecules 115 of the primary material 110 to attach and detach from the molecules of the attaching surface (e.g., the molecules 25 of the second surface 20), depending on the orientation of the molecules 115 of the primary material 110 and the molecules of the attaching surface. Specifically, the van der Waals force allows the primary material 110 within or on the setae 130 to attach to and peel away from the surfaces 10, 20 to reverse (release) the bond formed between the primary material 110 within/on the setae 130 and the surfaces 10, 20.

Impurities on or in the surfaces 10, 20, such as dirt, oil, and air pockets, do not substantially weaken the overall bond formed by the releasable adhesive 100 because of the many areas of contact between the setae 130 and the surface 10, 20. Specifically, the setae 130 form a plurality of independent bonds with the surface 10, 20, which allows the releasable adhesive 100 to bond even with the existence of some impurities affecting the bond at one or more limited points of interface.

The releasable adhesive 100, including each setae 130, may be designed to have a predetermined of load-bearing capability. For example, where a load to be bore is from a small object under tension loading, the load bearing capability of the releasable adhesive 100 may be between about 0.1 pounds of force per square centimeter (lbs/cm²) and about 1.0 lb/cm², wherein the area measurement (cm²) is the surface area of the primary material 110 within/on each setae 130. However, where the object is under shear loading, the load bearing capability of the releasable adhesive 100 may be between about 1.0 and about 20 lbs/cm².

In some embodiments, as also shown in FIG. 1, the primary material 110 is infused with an embedded material 120. In some embodiments, the embedded material 120 is a material being similar in composition (e.g., material composition or chemical composition) to the primary material 110. In other embodiments, the embedded material 120 is a material different than the primary material 110.

The embedded material 120 can include particles or pathways infused into a molecular structure of the primary material 110. The embedded material 120 may be infused into each of the setae 130 within the primary material 110. Alternatively, the embedded material 120 may be infused into selected setae 130, shown in FIG. 1.

In some embodiments, the embedded material 120 is selected to reinforce strength of the primary material. Reinforcing strength of the primary material allows the primary material to sustain against greater shear forces and pull forces.

In some embodiments, the embedded material 120 is used to increase electrical and/or thermal conductivity of the primary material 110. For example, doping (e.g., vary placement any numbering of electrons and holes within a molecular structure) can be used to increase conductivity of the primary material 110. Increasing conductivity of the primary material, and thus releasable adhesive 100, may be important in applications where the surfaces 10, 20 need to conduct electricity. For example, doping of the primary material 110 may be suitable in an application where the releasable adhesive 100 serves as a conductor within a battery application.

The emended material 120 is a conductive agent that may include a composition of one or more compounds that perform as a dry adhesive. For example, the embedded material 120 can include a polymer combined with a conductive filler.

The polymer is a liquid-like compound that has rheological (flow) properties that allow formability when combined with a conductive filler. Example polymers include, but are not limited to, polydimethylsiloxane (PDMS) and a mixture of poly(propylene glycol) bis(2-aminopropyl ether) and neopentyl glycol diglycidyl ether.

The conductive filler is a conductive material used to pass energy throughout the embedded material. Conductive fillers may include materials such as, but not limited to, carbon nanotubes, carbon black, metal particles, or combination thereof. Where metal particles are used, the particles can, for example, include nanoparticles and microparticles composed of materials including, but not limited to copper, silver, and gold.

In some embodiments (such as that illustrated in FIG. 1), the conducive fillers are in the form of particles that are positioned within the embedded material 120, the conductive fillers are in some embodiments preferably positioned in proximity to one another to allow flow of thermal and/or electrical conductivity.

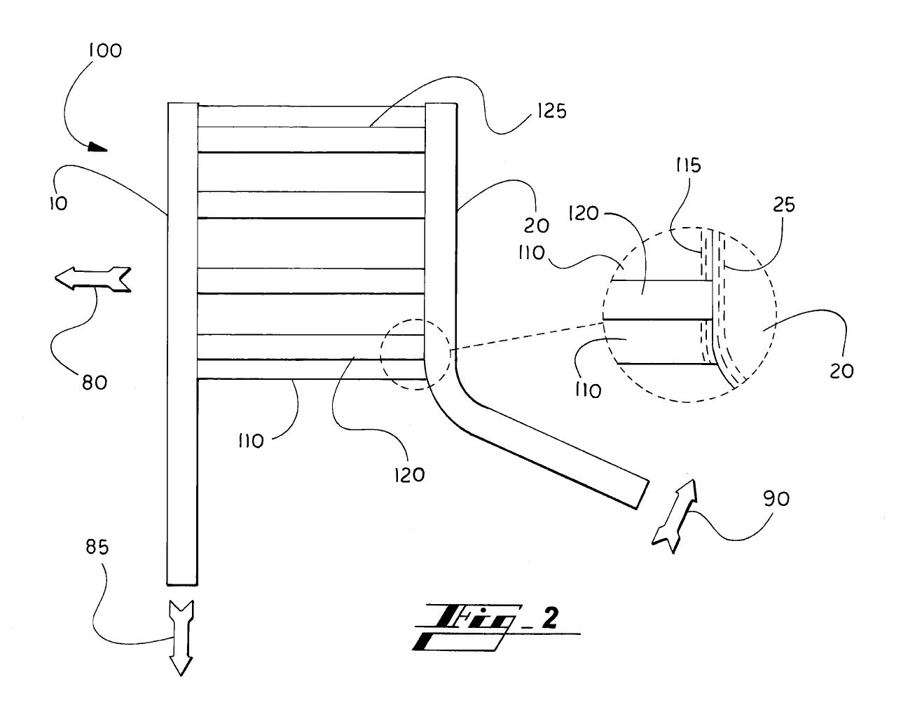

In some embodiments (such as that illustrated in FIG. 2), the embedded material 120 forms a pathway 125 within or around the primary material 110. The pathway 125 forms a continuous surface of connectivity between the embedded material 120 and the primary material 110. For example, the continuous surface is formed by a metal block.

The continuous surface can also be sized and shaped to conduct a specified amount of electrical (σ) or thermal (k) energy. Electrical conductivity and/or thermal conductivity may depend on a material composition of the continuous surface. For example, where the continuous surface is composed of silver, the electrical conductivity is approximately 6.3×10⁷ Siemens/meter (S/m), and where the continuous surface is composed of copper, the electrical conductivity is approximately 5.8×10⁷ S/m. Because silver has a higher electrical conductivity than copper, a silver continuous surface can have a surface area that is smaller than a copper continuous surface for accomplishing generally the same result.

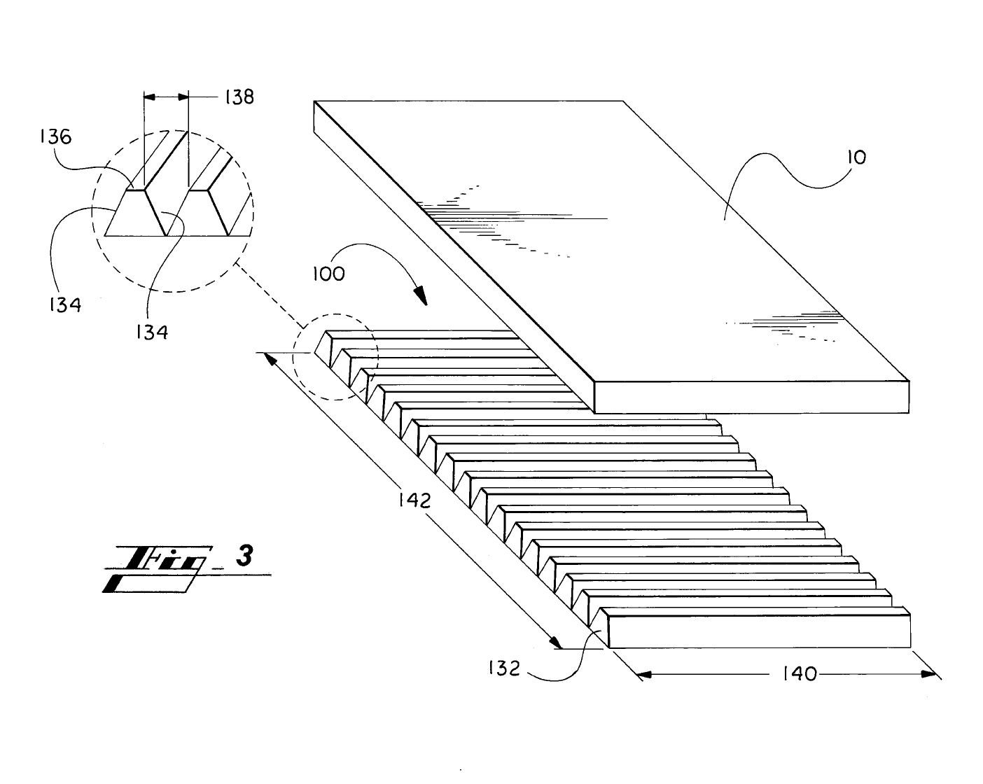

In another embodiment, illustrated in FIG. 3, the setae 130 are formed into an array of truncated prisms 132. Each truncated prism includes at least one side 134 and at top 136 (illustrated in the callout of FIG. 3), which serve as flat, generally flat, or smooth surfaces to maximize contact with an attaching surface (e.g., the first surface 10). The van der Waals force that can be exerted on the attaching surface is higher with greater contact area, and so maximizing contact with the attaching surface is a priority in design of the adhesive 100.

In some embodiments the truncated prisms can vary in geometric shape. For example, as illustrated in FIG. 3, the array of truncated prisms can be formed in the shape of a truncated pyramid, where each pyramid includes two sides 134 and top 136 that are used to generate sufficient van der Waals force for adhesion with the surfaces 10, 20. However, the array of truncated prisms can be in the form of a truncated cone (e.g., sloping or frustro-conical surface), where the side 134 extends around a circumference of a circular base.

Impurities on or in the surfaces 10, 20, such as dirt, oil, and air pockets, do not lead to a substantial weaken the overall bond because of the many areas of contact between the truncated prisms 132 and the surface 10, 20. Specifically, the truncated prisms 132 form a plurality of independent bonds with the surface 10, 20, which allows the releasable adhesive 100 to bond even with the existence of some impurities affecting the bond at one or more limited points of interface.

The array of truncated prisms 132 are extended across a defined width 140. The width 140 can range approximately between 1 millimeter (mm) and 20 mm. The truncated prisms repeat along a defined length 142 with a range similar to the width 140. Spacing between each prism 132 should be sufficient to allow contact to a surface (e.g., the first surface 10). For example, a space 138 between one edges of a first prism 132 and a subsequent prism 132 may be between 10 nanometers (nm) and 200 micrometers (μm).

In some embodiments, the truncated prisms 132 may include the embedded material 120. The embedded material 120 may be added (e.g., doped) into the microstructure of truncated prisms 132.

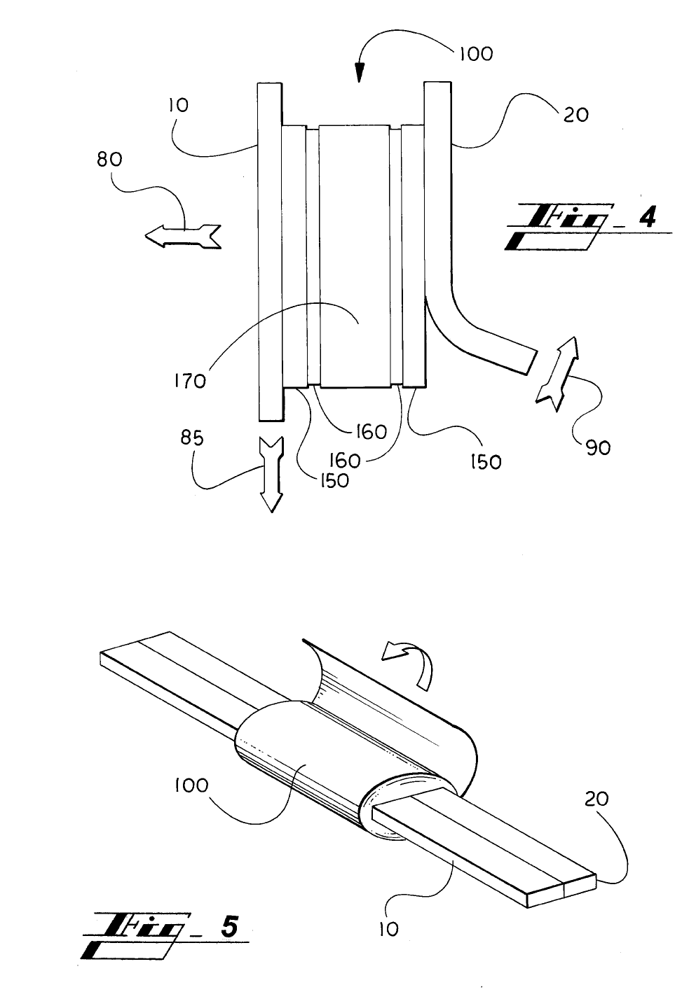

In another embodiment, illustrated in FIG. 4 the releasable adhesive 100 may include a plurality of layers including an adhesion pad 150, a skin 160, and a tendon 170. Collectively, the plurality of layers maximize areas of contact with the surfaces 10, 20 while maintaining stiffness a direction of applied loads (e.g., along the fibers of the fabric of the skin 160).

In this embodiment, the adhesion pad 150 (e.g., a polymer elastomer) attaches to the skin 160 (e.g., woven fabric) which is attached to a tendon (e.g., woven fabric). Attaching the adhesion pad 150 to the skin 160 and the tendon 170 provides strength enabling adhesion to maintain against shear force 85 and pull force 80. An example in FIG. 3 illustrates how the first surface 10 is maintained against shear forces 85 and pull forces 80 through stiffness of fabric (e.g., fibers) within the releasable adhesive 100. Additionally, the plurality of layers provide stiffness in a direction of peel loading (e.g., peel force 90), thus enabling release from the attached surface (e.g., the second surface 20 as illustrated in FIG. 4).

The adhesion pad 150 may include materials that behave elastically within a predetermined force capacity range of a desired application. The materials should ensure deformation losses (e.g., viscoelastic, plastic, or fracture) in the materials of the adhesion pad 150 are minimized or otherwise reduced. The adhesion pad 150 may include materials such as, but not limited to, silicone, PDMS, and the like. The adhesion pad 150 may have a thickness between 10 nm and 100 nm.

The skin 160 may include similar elastic materials that minimize deformation losses as described in association with the adhesion pad 150. The skin 160 may include woven fabric materials such as carbon fiber fabric, fiber glass, KEVLAR® (KEVLAR is a registered trademark of E. I. du Pont de Nemours and Company of Wilmington, Delaware), and the like. The skin 160 may have a thickness between 10 nm and 1 mm.

The tendon 170 may include woven fabric materials with high stiffness fibers such as glass fiber, nylon, and carbon-fiber, among others. The tendon 170 should be of a thickness that sufficient attaches the pad 150 to the skin 160. For example, the tendon 170 can have a length between 1 mm and 100 mm.

The connection between the tendon 170 and the adhesion pad 150 may have pre-defined dimensions, orientation, and spatial location according to particular a desired application. The pre-defined dimension can be altered to balance shear and normal loading requirements for the desired application.

In electrically and thermal conductive applications, the pad 150 can be doped with the embedded material 120. For example, the embedded material 120 can include metal nanoparticles as stated above. In some embodiments, the skin 160 and/or the tendon 170 can also be doped electrically and thermal conductive materials (e.g., carbon fiber fabric).

Where the tendon 170 attaches to the pad 150 can affect functionality of the releasable adhesive 100. Characteristics such as thickness of the tendon 170, material composition of the tendon 170, and positioning of tendon 170 with respect to the pad 150 can be set in various ways to achieve different results for desired performance in various applications. For example, positioning of the tendon 170 can affecting hanging ability. Attaching the tendon 170 at an edge of pad 150 allows increase strength of the releasable adhesive 100 in the shear direction, as illustrated in FIG. 4. However, attaching the tendon 170 on an inner surface of the pad 150 allows increased strength of the releasable adhesive 100 in the pull direction.

In another embodiment, illustrated in FIG. 5 the releasable adhesive 100 (e.g., setae 130, the prisms 132) may be formed as a flexible structure that can be molded to surround or otherwise connect surfaces. For example, the releasable adhesive 100 may function similar to single-sided tape.

In some embodiments, the releasable adhesive 100 can be included on one more than one surface for purposes of adhesion. For example, the releasable adhesive 100 may function as a double-sided tape.

The single-sided or double-sided tape may be used to position between, pinch together, wrap around, or otherwise hold together the surfaces 10, 20.

The single-sided or double-sided tape may utilize the releasable adhesive 100 in a non-conductive form or with conductive doping, using the embedded material 120. For example, the releasable adhesive 100 may be in the form of an electrically and/or thermal conductive, single-sided tape, which may be used to secure the surfaces 10, 20 to one another and pass energy (e.g., electrical currents) through one another and the single-sided tape, as illustrated in FIG. 5.

### III. Releasable Adhesive Application

The releasable adhesive 100 may be used to conductively join the surfaces 10, 20. Applications requiring conductive joining of materials may include battery manufacturing and electric motor manufacturing, among others.

Utilizing the releasable adhesive 100 to join conductive materials can reduce equipment down time when repairing and replacing parts by eliminating time required to disjoin a permanent bond (e.g., cutting a weld). Additionally, using the releasable adhesive 100 may reduce scraps and waste produced from breaking permanent bonds.

In electrical and thermal conducting applications, the primary material 110 can doped with a conductive embedded material 120. The conductive embedded material 120 can include material mentioned above (e.g., carbon nanotubes and carbon black).

Where the releasable adhesive 100 is used to secure battery tabs or other electrically and/or thermally conductive materials that are dissimilar in composition, the releasable adhesive 100 can be used to conductively bond the dissimilar materials without use of joining equipment (e.g., welders).

Using the releasable adhesive 100 instead of joining equipment can be beneficial where there is a desire to reduce/eliminate the use of joining fixtures and tooling. Additionally, the releasable adhesive 100 may be beneficial where reduction of production workspace is desirable. For example, when the releasable adhesive 100 is used, access locations for tooling (e.g., clamps on a tooling fixture) can be eliminated, which can reduce a production workspace.

In embodiments where the releasable adhesive 100 is in the form of a one-sided or double-sided tape. The thickness when securing stamped surfaces together should be as thin as possible (e.g., less than 0.1 mm). However, the thickness can be such to allow the releasable adhesive 100 to maintain a gap (e.g., up to 0.3 mm) based on a predetermined stand-off distance between parts, to allow gas to escape during welding, for example.

In some embodiments, the thickness of the tape is such that the releasable adhesive 100 can form around one or more objects (e.g., the surfaces 10, 20) or around the tape itself. The thickness in an application such as securing battery tabs for example can be between 100 μm to 0.1 mm.

### IV. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A releasable adhesive system, for joining a first conductive surface to a second conductive surface, comprising:
a primary material including at least one molecule configured to be positioned parallel with at least one molecule of the first conductive surface or the second conductive surface; and
a conductive embedded material, infused within the primary material to form an adhesive structure, wherein the adhesive structure has a conductivity greater than a conductivity of the primary material alone.

2. The releasable-adhesive system of claim 1, wherein the adhesive structure is configured to, in use, be removed from the first conductive surface or the second conductive surface in response to a peel force applied perpendicular to the at least one molecule of the first conductive surface or the second conductive surface.

3. The releasable-adhesive system of claim 1, wherein the conductive embedded material forms a continuous surface providing an uninterrupted electrical pathway from the first conductive surface to the second conductive surface.

4. The releasable-adhesive system of claim 1, wherein the conductive embedded material includes a plurality of conductive particles positioned in proximity to one another, forming an electrical pathway from the first conductive surface to the second conductive surface.

5. The releasable-adhesive system of claim 1, wherein the conductive embedded material is doped into the primary material to provide greater electrical or thermal conductivity than the primary material alone.

6. The releasable-adhesive system of claim 1, wherein the conductive embedded material structurally reinforces the primary material against a predetermined shear force or pull force.

7. The releasable-adhesive system of claim 1, wherein the primary material forms an array of element structures and the conductive embedded material is arranged in or on at least one of the element structures.

8. The releasable-adhesive system of claim 7, wherein at least one of the element structures is a setae.

9. The releasable-adhesive system of claim 7, wherein the array of element structures is a plurality of setae, and the primary material is arrange in or on at least one of the plurality of setae.

10. The releasable-adhesive system of claim 1, wherein the primary material is formed into a flexible structure configured to mold around the first and second conductive surfaces.

11. A releasable adhesive system, for joining a first conductive surface to a second conductive surface, comprising:
a primary material including at least one molecule configured to be positioned parallel with at least one molecule of the first conductive surface or the second conductive surface; and
a conductive embedded material, affixed to the primary material to form an adhesive structure, wherein the adhesive structure has a conductivity greater than a conductivity of the primary material alone.

12. The releasable-adhesive system of claim 11, wherein the adhesive structure is configured to, in use, be removed from the first conductive surface or the second conductive surface in response to a peel force applied perpendicular to the at least one molecule of the first conductive surface or the second conductive surface.

13. The releasable-adhesive system of claim 11, wherein the conductive embedded material forms a continuous surface providing an uninterrupted electrical pathway from the first conductive surface to the second conductive surface.

14. The releasable-adhesive system of claim 11, wherein the conductive embedded material includes a plurality of conductive particles positioned in proximity to one another, forming an electrical pathway from the first conductive surface to the second conductive surface.

15. The releasable-adhesive system of claim 11, wherein the conductive embedded material structurally reinforces the primary material against a predetermined shear force or pull force.

16. The releasable-adhesive system of claim 11, wherein the primary material forms an array of element structures and the conductive embedded material is arranged in or on at least one of the element structures.

17. The releasable-adhesive system of claim 16, wherein at least one of the element structures is a setae.

18. The releasable-adhesive system of claim 16, wherein the array of element structures is a plurality of setae, and the primary material is arrange in or on at least one of the plurality of setae.

19. The releasable-adhesive system of claim 11, wherein the primary material is formed into a flexible structure configured to mold around the first and second conductive surfaces.

20. A method for joining a first conductive surface to a second conductive surface, comprising:
applying, to the first surface, a releasable adhesive comprising:
a primary material including at least one molecule configured to be positioned parallel with at least one molecule of the first surface or the second surface; and
an embedded material, infused within the primary material to form an adhesive structure, wherein the adhesive structure has a conductivity greater than a conductivity of the primary material alone; and
joining to the releasable adhesive the second surface.
